(19) United States
(12) Patent Application Publication
(10) Pub. No.: US 2014/0287619 A1
(43) Pub. Date: Sep. 25, 2014

(54) Auxilliary Jack Plug With An Expandable Stand And Rotating Locking System

(71) Applicant: Robert Bashnagal, Garden City, NY (US)

(72) Inventor: Robert Bashnagal, Garden City, NY (US)

(21) Appl. No.: 13/848,061

(22) Filed: Mar. 21, 2013

(51) Int. Cl. H01R 13/73

(52) U.S. Cl. CPC H01R 13/73
USPC 439/529

(57) ABSTRACT

An auxiliary jack plug with an expandable mobile device stand is disclosed in the present invention. Said expandable mobile device stand comprises of a prism member with a plurality of expandable leg that the length of said leg is extendable and adjustable, and a disc member with an arc protrusion member connected to an edge of said disc member. When said auxiliary jack plug is plugged into a mobile device and said plurality of leg is in an expanding position on a flat surface, said arc protrusion member closely touches a front surface of said mobile device thus said expandable mobile device stand upholds the mobile device in an upright position. The angles that said arc protrusion touches a mobile device may be adjustable by a rotatable locking dial of said disc member, so that the mobile device is able to be held in varying angles.

### CROSS-REFERENCE

This is a continuation-in-part Application to the U.S. application Ser. No. 13/766,387, filed on Feb. 13, 2013, from which priority is claimed, and entirety of which is hereby incorporated by reference.

### BACKGROUND OF THE INVENTION

### Field of the Invention

The present invention relates to an accessory for mobile devices. More particularly, the present invention relates to an auxiliary jack plug with an expandable mobile device stand and a rotating locking system to not only stand an attached electronic device in an upright position but also to angle the attached electronic device for optimal viewing.

Mobile devices, such as mobile phones, tablets, gaming devices, etc. are commonly used now with a design to be held by the user of the device. Most devices do not allow for standing said device in an upright position on a desk or table. Additionally, many mobile devices provide audio to their users, for examples, audio from music, movies or games. Most often mobile devices provide these audio to earphones using audio plugs inserted into a jack located somewhere on one side of the mobile device.

When a mobile device user purchases a mobile device, usually an earphone comes along with the purchase as a standard accessory. But usually there is no stand for holding a mobile device upright on a table. The thought being that the audio plug is used for listening and nothing more. That means most of the time, if the electronic device is not being held in a users' hands or placed flat in one's lap or flat on one's desk, said user will be at a loss for other positioning possibilities with the device itself. Many times it is desirable to have the mobile device in an upright position. Others may want to view the device at the same time or an individual user, such as a school student may need to be able to use his or her hands for some other purpose than holding the electronic device.

Also there are more and more schools in the United States using tablets in replacing printed text books. There are also times that it is more desirable to have the tablets held in an upright position. This is so students can free their hands to do other things while still having a good position for viewing with the tablet and to be able to see content on said tablets' screen while also listening to the audio.

Though there are some stands as additional accessories to mobile devices, mobile users have to pay additional money for these additional accessories and cannot combine them with the audio plug feature of the device itself. Thus it is desirable to have a portable accessory for mobile devices that functions as a standard accessory to mobile devices, such as a jack plug, and at the same time, as a stand for holding the mobile device upright with the inclusion of an up and down positioning leg system and the additional feature of pivoting the device itself for various viewing angles. It is also more desirable to have the ability to vary the angles of the mobile device that is held by a stand to varying angles depending upon glare issues from sunlight, overhead lighting, or the table and chair positions related to said users.

### SUMMARY OF THE INVENTION

In an exemplary embodiment of the present invention, there is disclosed an auxiliary jack plug with an expandable mobile device stand to elevate or lower the attached device and the ability to angle said device as well. Said invention comprises a standard jack plug and an expandable mobile device stand attached to said jack plug. The expandable mobile device stand comprises a prism member, a plurality of legs attached to an edge of the prism, a disc member connected to a base of the prism and an arc protrusion attached to said disc member. The plurality of leg may either be collapsed towards a side of the prism member, or be expanded away from the side of the prism member. The plurality of leg may also be extendable and adjustable in length to accommodate various sizes of mobile devices. The arc protrusion is connected to the disc member in such a position so that when the auxiliary jack plug is plugged into a mobile device, and when the plurality of leg is in the expanding position and is placed on a flat surface, the arc protrusion member closely touches a front surface of the mobile device. Thus the mobile device is held upright by the plugged in auxiliary jack plug of present invention. The angles of said arc protrusion member touching a mobile device can be adjusted via a rotatable locking dial of said disc member, so that said mobile device can be held in various angles.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a prospective view of one embodiment of present invention with legs in a collapsed position.

FIG. 2 is a prospective view of one embodiment of present invention with legs in an expanding position.

FIG. 3 is a prospective view of one embodiment of present invention with legs in an expanding position and legs are in an extending position.

FIG. 4 is a front view of one embodiment of present invention with legs in an expanding position and legs are in an extending position.

FIG. 5 is a prospective view of one embodiment of present invention is plugged into a mobile tablet and holds it in an upright position.

FIG. 6 is a prospective view of one embodiment of present invention is plugged into a mobile phone and holds it in an upright position.

FIG. 7 is a prospective view of one embodiment of present invention showing the rotatable locking dial of a disc member and varied shape of prism member and legs.

### DESCRIPTION OF THE PREFERRED EMBODIMENT

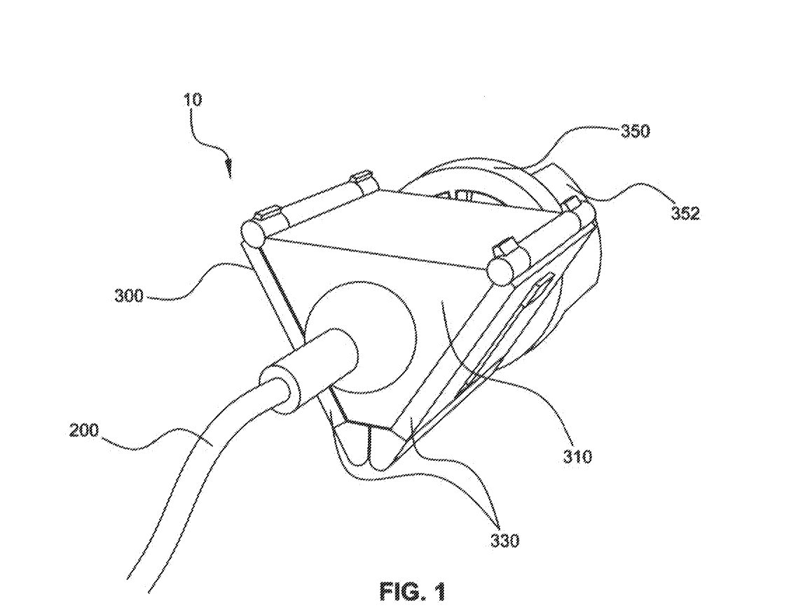

Referring to FIG. 1-4, there is disclosed an auxiliary jack plug with an expandable mobile device stand 10, comprising an auxiliary jack plug 100 with a cable 200 and a middle part (not shown) connecting the auxiliary jack plug and the cable, and an expandable mobile device stand 300, further comprising: a an prism member 310, a plurality of leg 330, each attached to an edge 312 of said prism member 310, and a disc member 350 connected with a base 314 of said prism member 310, and said disc member 350 further includes a arc protrusion member 352 connected with an edge 354 of said disc member.

In one embodiment of the present invention, said prism member 310 is a trapezoid prism, with a small side 316 at the bottom, a bigger side 318 at the top, and two side sides 320.

In one embodiment of the present invention, the prism member 310 covers the middle part (not shown) of the present invented device and might also cover a part of the auxiliary jack plug 100 and of the cable 200.

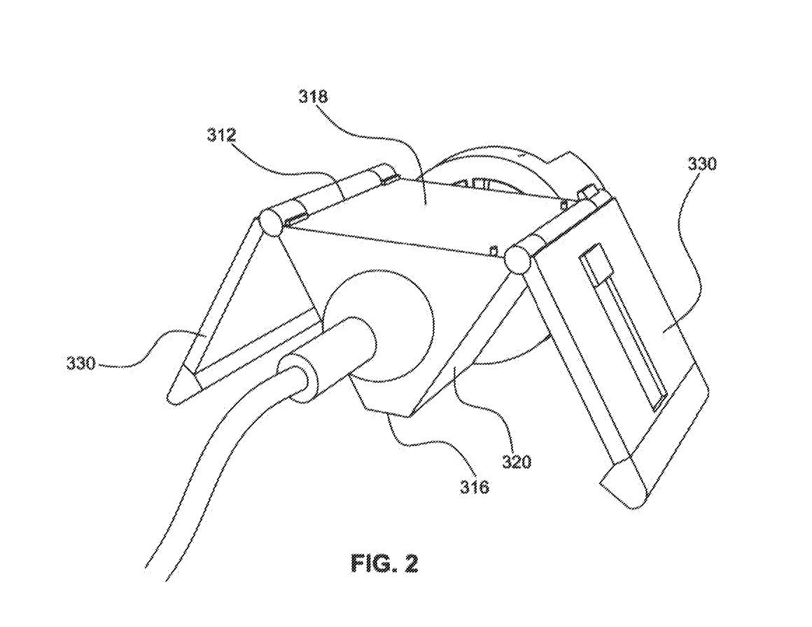

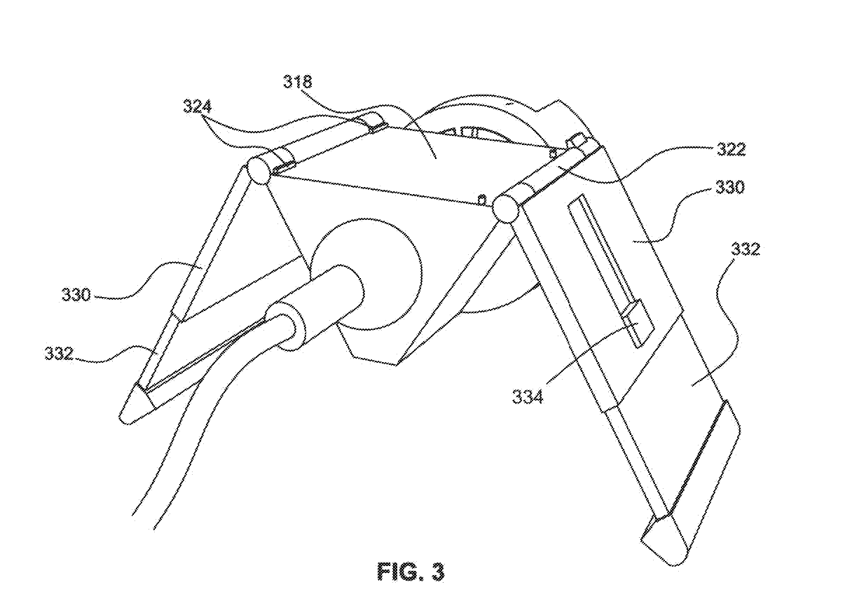

In another embodiment of the present invention, a plurality of leg 330 can either be in a collapsed position (as shown in FIG. 1) or in an expanding position (as shown in FIG. 2), towards to or away from a side of said prism member 310. Yet in another embodiment of the present invention, said plurality of leg 330 further comprises a retractable extending member 332 which can extend the length of said legs (as shown in FIG. 3). Yet in another embodiment of the present invention, said retractable extending member 332 may slide into or out of the plurality of leg 330. In another embodiment of the present invention, when said retractable extending member 332 slides in or out of the plurality of leg 330, it can be locked by a locking means 334 at any position along the path, so that the total length of said leg is adjustable. Thus a devices of present invention is able to accommodate various sizes of mobile devices when the device is used in conjunction with the auxiliary jack plug being plugged on the mobile device.

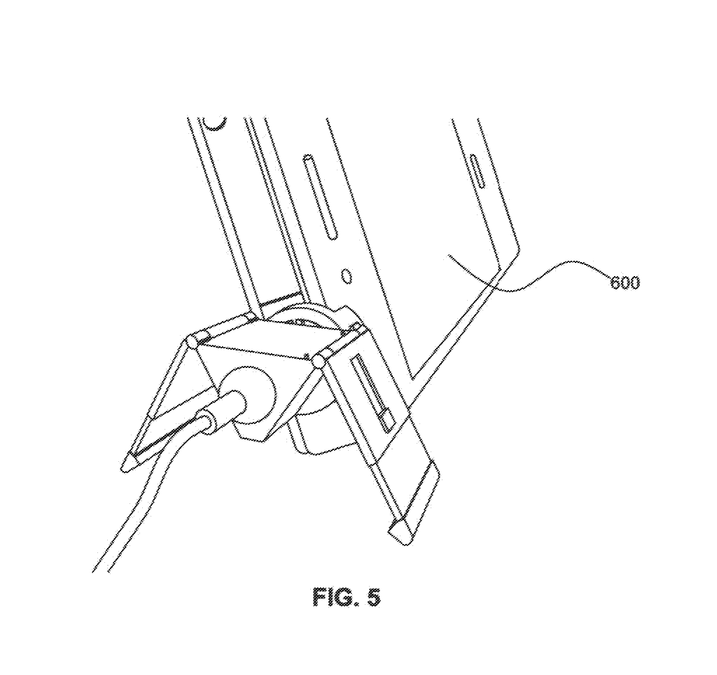

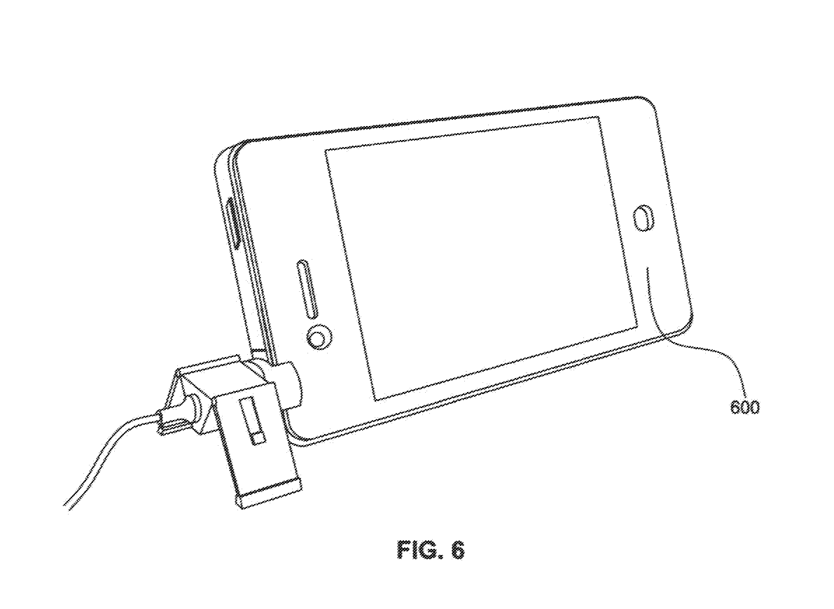

In another embodiment of the present invention, said disc member 350 is in between said auxiliary jack plug 100 and said expandable mobile device stand 300, and wherein said arc protrusion 352 has a arc surface 354 align with the edge of said disc member 356 and an flat surface 358 opposite to said arc surface 356, and said arc protrusion 352 is connected to said disc member 350 in such a position that when said auxiliary jack plug 100 is plugged into a mobile device 600 (i.e. a tablet in FIG. 5, a mobile phone in FIG. 6), and when said a plurality of legs 330 is in an expanding position, with said retractable extending member 332 either in a retracted position or a extending position, on a flat surface, said flat surface 358 of said arc protrusion 352 closely touches a front surface of said mobile device and said expandable mobile device stand 300 upholds said mobile device in an upright position.

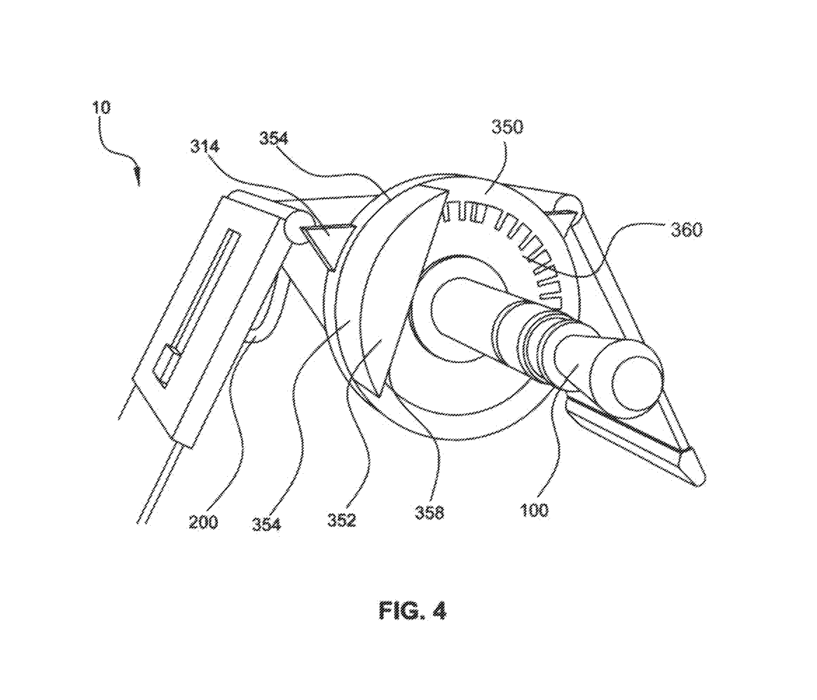

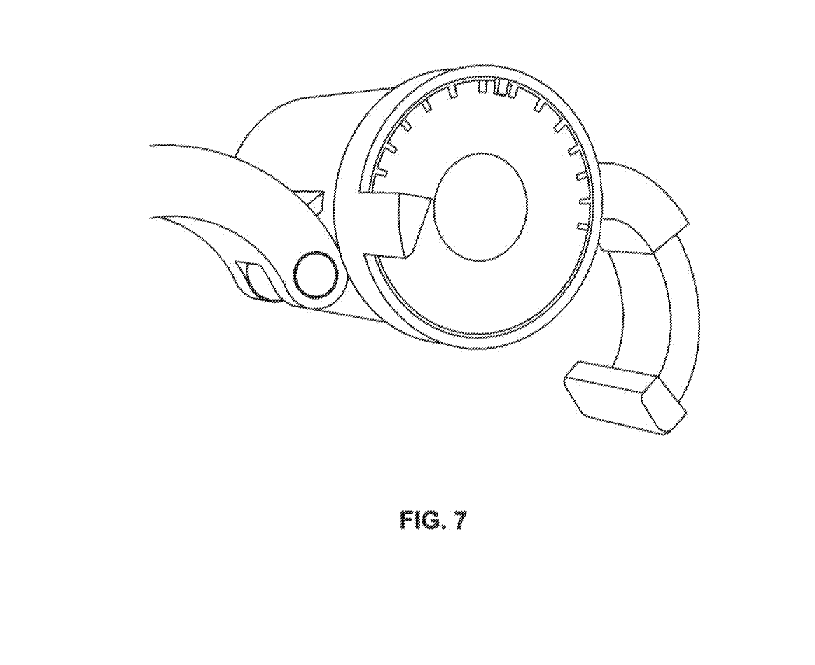

In another embodiment of the present invention, said disc member 350 further comprises a rotatable locking dial 360 (as shown in FIG. 4, also in FIG. 7). When said dial 360 is turned and locked into various positions, the angles that said arc protrusion member touches a mobile device also can vary. Thus the mobile device 600 can be held in various angles to meet different needs from users.

Yet in another embodiment of present invention, said a plurality of leg 330 is connected to the edge 312 of side sides 320 of the trapezoid prism 310 by fasten means such as a hinge 322, wherein said hinge has a small protrusion 324 that when said a plurality of leg 330 is in expanding position, said small protrusion 324 contacts with the bigger side 318 of the trapezoid prism 310 thus preventing further expansion of said a plurality of leg.

In another embodiment of the present invention, said expandable mobile device stand may be formed from any suitable materials, including but not limited to plastic, rubber, or metal, while providing protections to the connection between the auxiliary jack plug and cable and also providing a hard, smooth, and cosmetically appealing surface.

In another embodiment of the present invention, the shape of the prism member and the plurality of leg can be varied as shown in FIG. 7, so long as the variations fit the purpose of the present invention and are cosmetically appealing.

Yet in another embodiment of the present invention, said auxiliary jack plug is an audio jack plug.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An auxiliary jack plug with an expandable electronic mobile device stand, comprising:
a) an auxiliary jack plug with a cable and a middle part connecting the auxiliary jack plug and the cable, and
b) an expandable electronic mobile device stand comprising:
i. an prism member,
ii. a plurality of one or more legs, each attached to an edge of said prism member,
iii. a disc member connected with a base of said prism member, and said disc member further includes an arc protrusion member connected with an edge of said disc member.

2. An auxiliary jack plug with an expandable electronic mobile device stand of claim 1, wherein said expandable electronic mobile device stand covers the middle part of the auxiliary jack plug, and might also cover a part of the auxiliary jack plug and of the cable.

3. An auxiliary jack plug with an expandable electronic mobile device stand of claim 2, wherein said expandable electronic mobile device stand may be formed from any suitable materials, including but not limited to plastic, rubber, or metal, while providing protections to the connection between the auxiliary jack plug and cable and also providing a hard, smooth, and cosmetically appealing surface.

4. An auxiliary jack plug with an expandable electronic mobile device stand of claim 3, wherein said plurality of one or more legs can either be in a collapsing or an expanding position, towards to or away from a side of said prism member.

5. An auxiliary jack plug with an expandable electronic mobile device stand of claim 4, wherein said plurality of one or more legs further comprises a retractable extending member which can extend the length of said legs when said retractable extending member is in an extending position.

6. An auxiliary jack plug with an expandable electronic mobile device stand of claim 5, wherein said retractable extending member is able to move up or down so that the total length of said plurality of legs is adjustable in order to accommodate an electronic mobile device of varying sizes when said device is used in conjunction with said auxiliary jack plug on said electronic mobile device.

7. An auxiliary jack plug with an expandable electronic mobile device stand of claim 6, wherein said disc member is located in between said auxiliary jack plug and said expandable electronic mobile device stand, and wherein said arc protrusion has an arc surface aligned with the edge of said disc member and a flat surface opposite to said arc surface, and said arc protrusion is connected to said disc member in such a position that when said auxiliary jack plug is plugged into an electronic mobile device, and said plurality of legs is in an expanding position, with said retractable extending member either in a retracted position or an extending position, on a flat surface, said flat surface of said arc protrusion closely touches a front surface of said electronic mobile device and said expandable electronic mobile device stand upholds said electronic mobile device in an upright position.

8. An auxiliary jack plug with an expandable electronic mobile device stand of claim 7, wherein said disc member further comprises a rotatable locking dial member, which is able to be turned and locked into various positions so that said arc protrusion touches said mobile device at varying angles, thus said electronic mobile device is able to be held in varying angles in relation to said flat surface upon which said plurality of legs stand upon.

9. An auxiliary jack plug with an expandable electronic mobile device stand of claim 8, wherein said prism member is in a shape of a trapezoid prism, with a bigger side, a smaller side, and two side sides, and said smaller side is at the bottom and said bigger side is at the top.

10. An auxiliary jack plug with an expandable electronic mobile device stand of claim 9, wherein said plurality of one or more legs is connected to the side sides of the trapezoid prism by fasten means such as a hinge, wherein said hinge has a small protrusion that when said plurality of one or more legs is in an expanding position, said small protrusion contacts with the bigger side of the trapezoid prism thus preventing further expansion of said plurality of one or more legs.

11. An auxiliary jack plug with an expandable electronic mobile device stand of claim 10, wherein said auxiliary jack plug is an audio jack plug.
